(19) United States
(12) Patent Application Publication
(10) Pub. No.: US 2026/0342186 A1
(43) Pub. Date: Oct. 29, 2026

(54) Flux Engine for Generating Directed Magnetics Fields

(71) Applicant: Overawe, LLC, Alice, TX (US)

(72) Inventor: Encarnacion Gonzalez, Alice, TX (US)

(73) Assignee: Overawe, LLC, Alice, TX (US)

(21) Appl. No.: 19/190,620

(22) Filed: Apr. 26, 2025

(51) Int. Cl. H02K 16/00; B64G 1/40; H02K 1/22

(52) U.S. Cl. CPC H02K 16/00; B64G 1/417; H02K 1/22

(57) ABSTRACT

As is scientifically well known, magnetic flux is a physical force (i.e. the Lorentz force and Ampere's force). The invention utilizes a plurality of electromagnetic and plasma coils to create high pressure, high velocity magnetic flux directed through variable exhaust nozzles or a cone shaped electrical coil to create an electromagnetic field wherein the created electromagnetic field may propel a craft by interacting with the existing, ambient magnetic field.

### CROSS-REFERENCE TO RELATED APPLICATIONS

This application takes benefit of U.S. Prov. Pat. App. No. 62/872,115 filed Jul. 9, 2019, it's subsequent U.S. patent application Ser. No. 16/912,801 filed Jun. 26, 2020, and, because of a restriction requirement, a divisional U.S. Continuation-in-Part patent application Ser. No. 18/097,312 filed Jan. 16, 2023, and of U.S. Continuation-in-Part patent application Ser. No. 18/431,998 filed Feb. 4, 2024 all of which are included, in their entireties, by reference.

### FIELD OF THE INVENTION

This invention relates to the generation of directed magnetic fields. As is scientifically well-known magnetic flux is a physical force (i.e. the Lorentz force and Ampere's force). This invention utilizes a plurality of electromagnetic and or plasma coils to create high pressure, high velocity magnetic flux directed through variable exhaust nozzles or cone shaped coils to create a directed magnetic field. These directed magnetic fields may be oriented in any direction.

### BACKGROUND OF THE INVENTION

For many years extensive research has been done by private and government entities directed towards creating practical long-term infinite distance propulsion systems for spacecraft. Electromagnetic flux fields exist throughout the known universe. Accordingly, a system that utilizes existing, ambient electromagnetic fields by directing a generated magnetic flux field in a specific direction to interact with the existing, ambient magnetic flux fields is desirable.

### SUMMARY OF THE INVENTION

The present invention relates to spacecraft propulsion systems which utilize magnetic flux as a physical force in the vacuum of outer space. The system uses a plurality of coils of electrically conductive material, super conducting material, or plasma coils designed to create high density, high magnetic flux pressure, high velocity electromagnetic flux fields routed through a variable exhaust nozzle or a cone shaped coil to interact with existing, ambient magnetic fields. The interaction of the created electromagnetic flux fields with the existing, ambient magnetic fields results in motion. The present invention also predicts and monitors where existing, ambient magnetic field lines are and orients the directionality of the plurality of coils to achieve motion in a specific direction.

The system may be powered by banks of capacitors or super capacitors. The magnetic fields produced may interact with a plurality of electric power coils to create electric power for the system. Solar power, a nuclear reactor, a fusion reactor, or batteries may optionally power the system.

This invention utilizes a plurality of electromagnetic and or plasma coils to produce high pressure, high velocity magnetic flux (Lorentz force, Ampere force). This force is oriented in any one of a multiplicity of directions allowing it to interact directionally with existing, ambient electromagnetic flux fields.

### BRIEF DESCRIPTION OF THE DRAWINGS

FIG. 1 shows a side cutaway view of a magnetic flux generator 99.

FIG. 2 shows a detailed side cutaway view of a magnetic flux generator 99 with flux pressure controllers 105 at both ends.

FIG. 3 shows a diagonal view of the optional two separate halves of the inner central conduit 103 with retainer rings 110 and a single flux pressure controller 105.

FIG. 4a shows a diagonal view of inner central conduit 203 with two formed, unwound pressure controllers 210 and 220 affixed.

FIG. 4b shows a detailed side cutaway view of inner central conduit 203 with two formed, wound pressure controllers 210 and 220 affixed.

FIG. 5 shows a detailed side cutaway view of inner central conduit 303 with two formed, wound pressure controllers 310 and 320 affixed.

FIG. 6a shows a detailed side cutaway view of two formed, wound pressure controllers 410 and 420 wherein one is concentrically enclosed in the other.

FIG. 6b shows detailed side cutaway view of an alternative embodiment using a single formed, wound pressure controller 420.

FIG. 7 shows a longitudinal section of an embodiment of a rim driven propellor 508 mounted in nacelle/pod 501. Nacelle/pod 501 may be positioned freely with respect to shaft 500.

FIG. 8a shows a cross-section rim driven propellor 508 mounted in nacelle/pod 501 pictured in FIG. 7.

FIG. 8b shows a detail of a portion of the tip of a rotor 507 as it passes by a large stator element 504 in an embodiment of the present invention. A large stator element 504 presents a less focused, less directed beam of electromagnetic energy to the rotor 507 as it passes by.

FIG. 8c shows a detail of a portion of the tip of a rotor 507 as it passes by a small stator element 504a in an embodiment of the present invention. A small stator element 504a presents a more focused, more directed beam of electromagnetic energy to the rotor 507 as it passes by.

FIG. 9 shows a cross-sectional view of the detail of a portion of the tip of a rotor 507 as it passes by a large stator element 504 in an alternative embodiment of the present invention. The rotor 507 is supported and guided by two peripheral electromagnetic guides 509a and 509b running in two concentric guide channels 507c and 507d.

FIG. 10 shows a cross-sectional view of the detail of a rotor 507 configured between large stators 504 on opposite sides of the stator ring in an alternative embodiment of the present invention. The rotor 507 is supported and guided by two peripheral electromagnetic guides 509a and 509c running in two concentric guide channels 507c and 507d. The two peripheral electromagnetic guides 509a and 509c are different in cross-section as shown.

FIG. 11 shows a cross-sectional view of the detail of a portion of the tip of a rotor 507 as it passes by a large stator element 504 in an alternative embodiment of the present invention. The rotor 507 is supported and guided by two peripheral electromagnetic guides 509a and 509c running in two concentric guide channels 507c and 507d. The two peripheral electromagnetic guides 509a and 509c are different in cross-section as shown. A solenoid controlled braking and stabilizing system is shown in components 510 through 514. Inside of rotor 507 is integral auger type blade 516 as shown in FIG. 10.

FIG. 12 shows a cross-section of the drive elements of an embodiment of the present invention pictured in FIG. 11. Peripheral electromagnetic guide 509c is constructed in two halves of concentrically wound wire (as 509a is in FIG. 11) showing that the form of both of the peripheral electromagnetic guides (509c) may be different (as shown in FIG. 11) or the same (as shown in FIG. 9).

FIG. 13 shows a diagonal view of integral auger type blade 516 affixed inside a rotor.

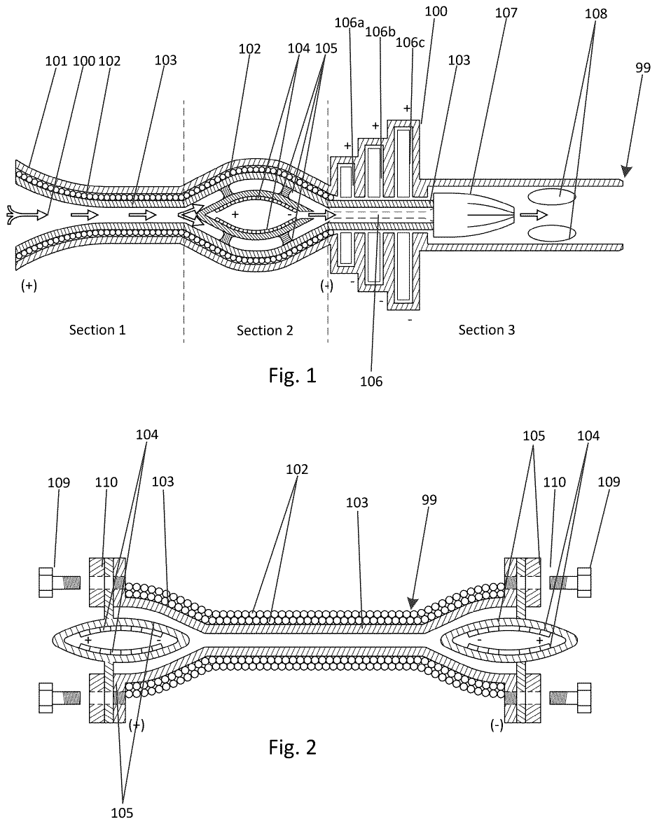

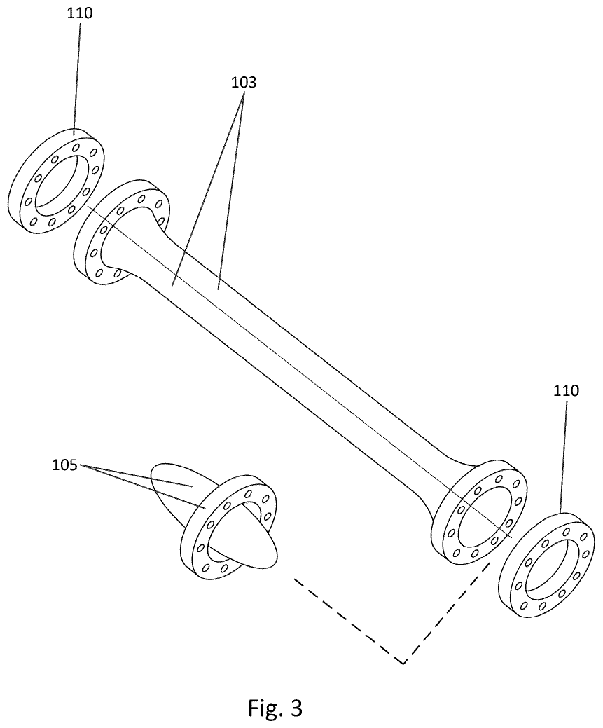

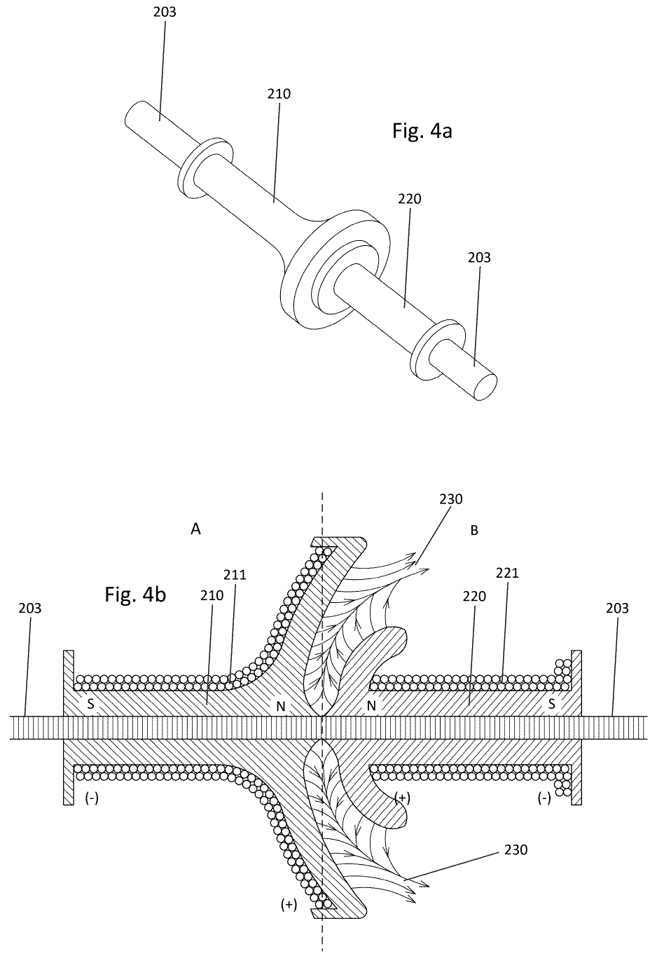

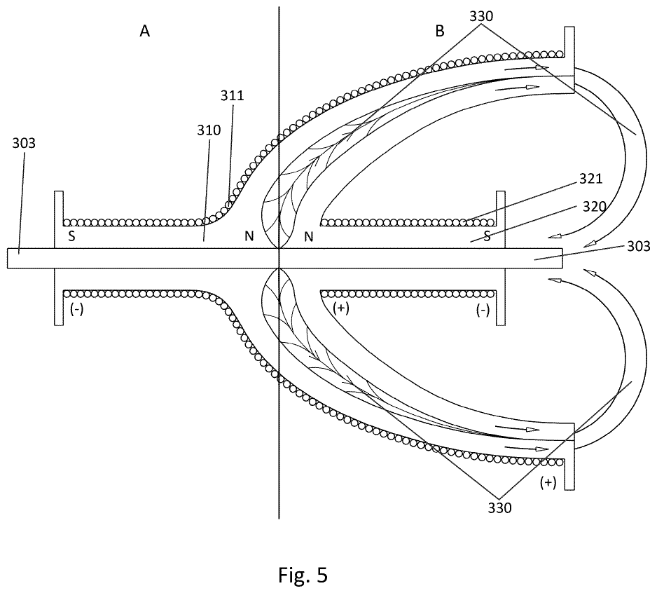

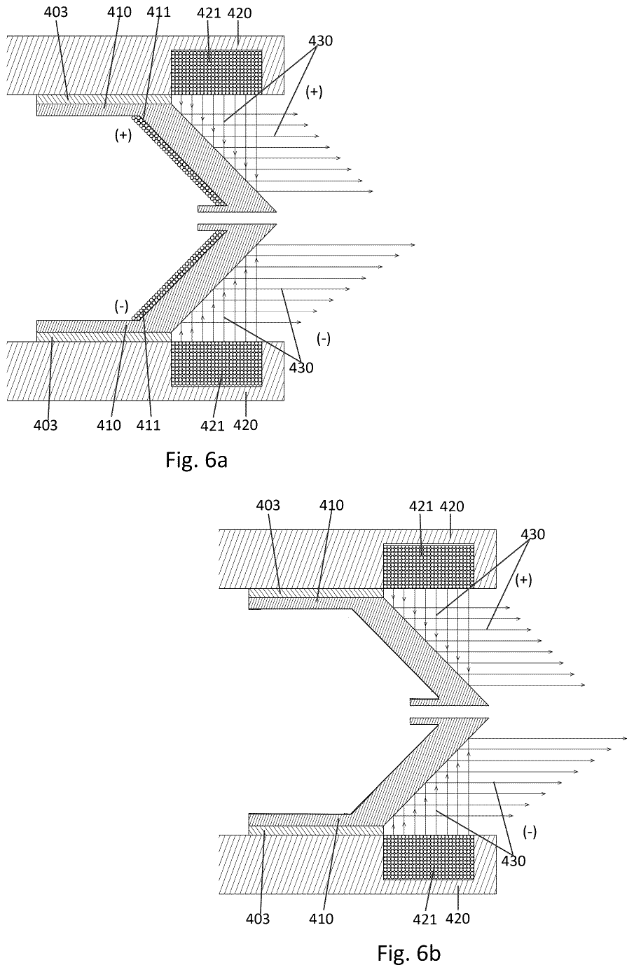

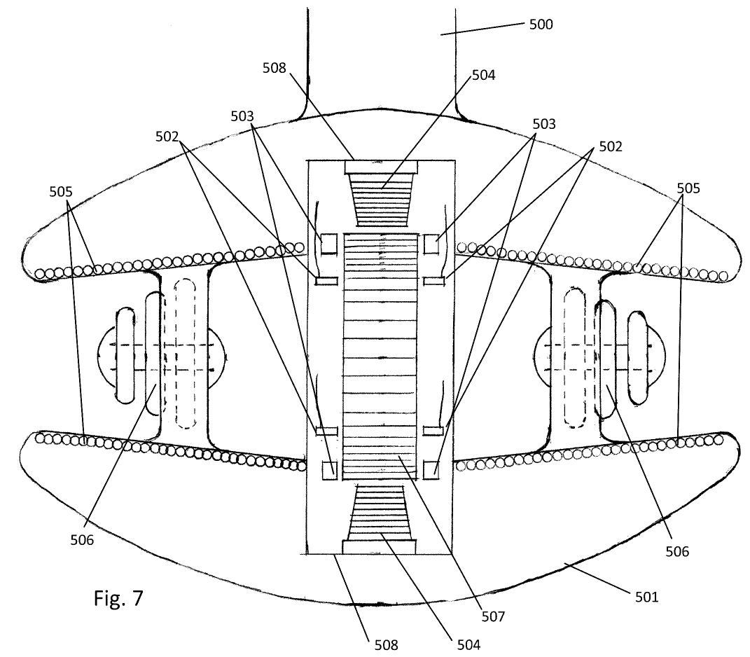

### DETAILED DESCRIPTION OF THE INVENTION

The invention is not limited to the embodiments shown which only represent examples of the current invention.

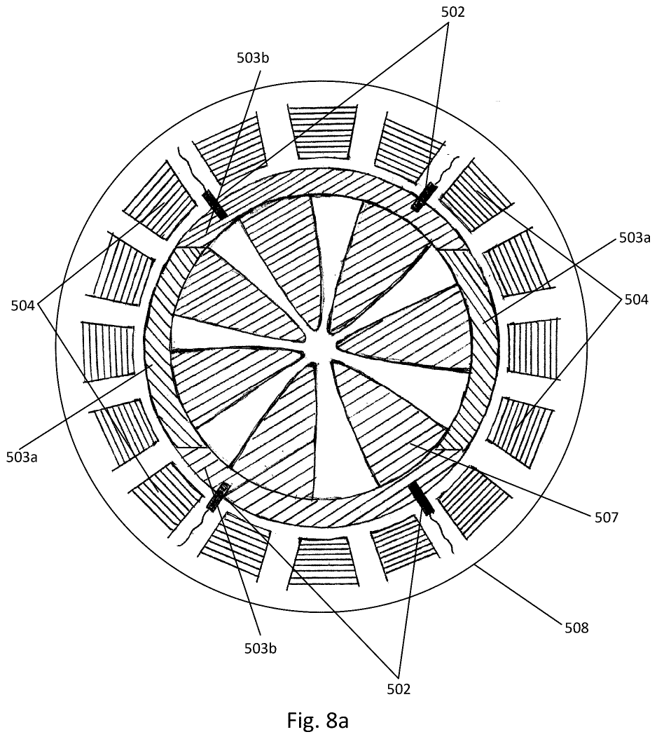

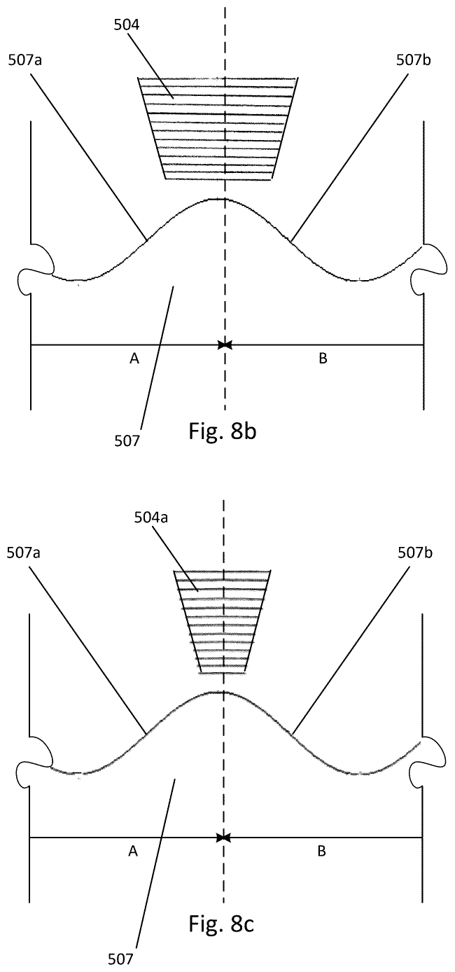

Referring to FIGS. 7, 8a, 8b, and 8c, nacelle/pod 501 is affixed to the end of mounting shaft 500 and is freely rotatable with respect to mounting shaft 500. Note that nacelle/pod 501 may rotate horizontally 360 degrees and it may be rotated vertically except only as limited by mounting shaft 500. An electronic controller controls the orientation of nacelle/pod 501 with respect to mounting shaft 500 and the direction of rotation of rotor 507 thus controlling the directional orientation of the magnetic field generated by the rim driven propellor (RDP) unit 508.

The rim driven propellor (RDP) unit 508 is comprised of: 1) Rotor 507 constructed from, including but not limited to, electrically conductive or super conductive material; 2) Multiple electrically energized large stators 504 arranged circumferentially around rotor 507; 3) Stationary axial magnetic bearings 503, 503a, and 503b arranged laterally around the tips of the blades of rotor 507; and; 4) Position sensors 502. The multiplicity of large stators 504 operate on rotor 507 through magnetic induction. Said system is further comprised of coil windings 505 within nacelle/pod 501 and electric power coils 506. Those having skill in the art will recognize that coil windings 505 may be constructed in multiple layers.

The multiplicity of large stators 504 control the polar orientation of, and the intensity of, the electrical charge of rotor 507. The multiplicity of large stators 504 may be sequentially energized to cause rotor 507 to rotate either clockwise or counterclockwise producing a pulsating magnetic field with its flux polarity generally oriented in either longitudinal direction along the rotational axis of rim driven propellor (RDP) unit 508. By this means the device may be made to emit a directionally oriented magnetic field in either direction.

Rotor 507 has a lobe design around the perimeter and is integral to said rotor. Said rotor may be constructed of diamagnetic materials and or alloys thereof, including but not limited to, superconductors, copper, aluminum, iron, steel, magnesium, etc. When stators 504 and or 504a are energized, the aforementioned diamagnetic materials may create opposing magnetic fields thus creating greater torque between stators and the lobe design as described in FIGS. 8b and 8c thus increasing RPM's of said rotor with minimal input power. When energized, the multiplicity of large stators 504 act as radial magnetic bearings to center rotor 507 during rotation and also electrically charge rotor 507. As rotation of the electrically charged rotor 507 increases, the blades of rotor 507 produce a varying electromagnetic wake in the generated magnetic flux, which may be aligned along a selected magnetic field line to propel a craft through a vacuum along an existing magnetic field line.

To prevent or limit dispersion of said magnetic flux, coil windings 505 within nacelle/pod 501 may be energized to concentrate and channel flux through electric power coils 506 to produce electric power. Any power generated by electric power coils 506 may be reused to power the system. Those having skill in the art will recognize that coil windings 505 may have multiple layers. Also, nacelle/pod 501 may optionally be lined or layered with materials that deflect and channel the generated magnetic flux including, but not limited to, pyrolytic carbon/graphite. Stationary axial magnetic bearings 503, 503a and 503b located on both sides of rotor 507 laterally locate rotor 507 and prevent rotor 507 from contacting surfaces in rim driven propellor (RDP) unit 508. Position sensors 502 monitor revolutions per minute, rotor charge, and rotor location and supply this data to an electronic controller.

FIG. 8b shows a close up, side view of the integral lobe design around the perimeter of said rotor 507 as said lobe passes by large stator element 504. Large stator element 504 presents a less focused, less directed beam of electromagnetic energy to the lobes of rotor 507 as it passes by. When large stator 504 is energized on side A of lobe 507a it will force the rotor 507 to rotate in the direction shown by line A. When large stator 504 is energized on side B of lobe 507a it will force the rotor 507 to rotate in the direction shown by line B. The number of lobes 507a on the tip (or edge) of rotor 507 is at least one and may vary in shape and depth to maximize torque and minimize power input and overall efficiency. The number of large stators 504 is at least one but the height of large stators 504 is set to match the lobe heights of rotor 507 to energize large stators 504 at the proper time to rotate rotor 507 in the direction indicated by line A or line B. A number of equally spaced large stators 504 circumferentially placed around rotor 507 may be energized all, or part of, the time before and during operation of the rotor 507 to act as magnetic bearings to physically suspend the rotor 507 to prevent contact with the large stators 504 and other surfaces. As rotor 507 is energized by large stators 504 and begins rotation, rotor 507 generates power by magnetically inducing current in some fraction of large stators 504 thus maintaining the electric charge of rotor 507.

FIG. 8c shows a close up side view of the integral lobe design around the perimeter of said rotor 507 as it passes by small stator element 504a. Small stator element 504a presents a more focused, more directed beam of electromagnetic energy to the lobes of rotor 507 as it passes by. When small stator element 504a is energized on side A of lobe 507a it will force the rotor 507 to rotate in the direction shown by line A. When small stator element 504a is energized on side B of lobe 507a it will force rotor 507 to rotate in the direction shown by line B. The number of lobes 507a on the tip (or edge) of rotor 507 is at least one and may vary in shape and depth to maximize torque and minimize power input and overall efficiency. The number of small stators 504a is at least one but the height of small stators 504a is set to match the lobe heights of rotor 507 to energize small stators 504a at the proper time to rotate rotor 507 in the direction indicated by line A or line B. A number of equally spaced small stators 504a circumferentially placed around rotor 507 may be energized all, or part of, the time before and during operation of the rotor 507 to act as magnetic bearings to physically suspend the rotor 507 to prevent contact with the small stators 504a and other surfaces. As rotor 507 is energized by small stators 504a and begins rotation, rotor 507 generates power by magnetically inducing reverse currents in some fraction back into small stators 504a thus maintaining the electric charge of said rotor 507.

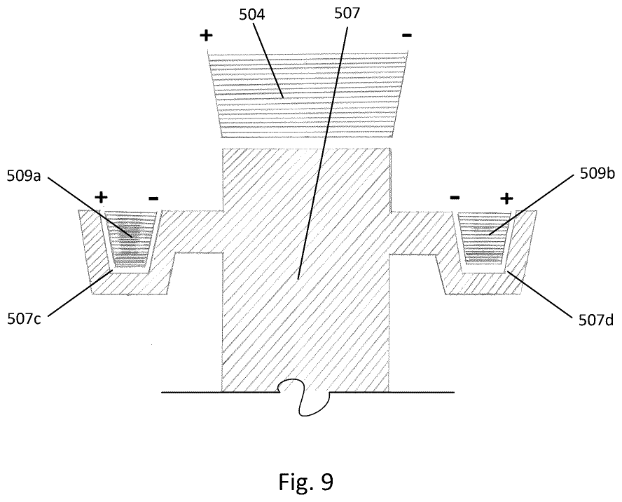

Referring now specifically to FIG. 9, a detail of an alternative embodiment of the outer periphery of rotor 507 as it passes an individual large stator element 504 is shown. In this embodiment, rotor 507 is supported and stabilized by two concentric guide channels 507c and 507d in which two peripheral electromagnetic guides 509a and 509b circumferentially run. Each peripheral electromagnetic guide 509a and 509b is circumferentially constructed in at least one segment wherein each segment is linearly constructed. The electromagnetic forces generated by the peripheral electromagnetic guides 509a and 509b act as a frictionless bearing surface which keeps rotor 507 isolated in space and acts as a magnetic bearing to physically suspend the rotor 507 preventing contact with large stators 504, peripheral electromagnetic guides 509a and 509b, and other surfaces. The same kind of structure may be used with rotor 507 and small stators 504a.

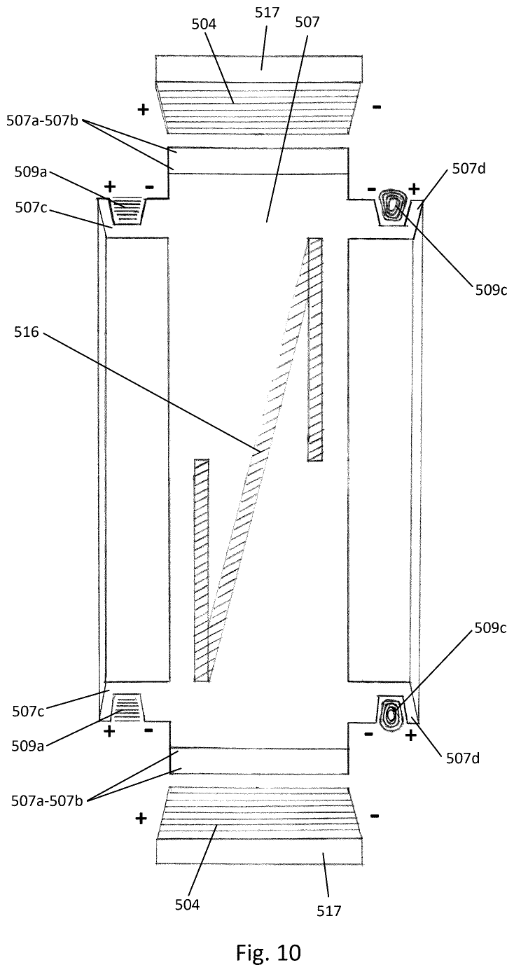

Referring now to FIGS. 8b, 8c, and 9 through 13 an alternative embodiment of rotor 507 as configured inside a circumferential ring of individual stators 504r comprising large stators 504 is shown. In this embodiment, rotor 507 is supported and stabilized by two concentric guide channels 507c and 507d in which two peripheral electromagnetic guides 509a and 509c circumferentially run. Each peripheral electromagnetic guide 509a and 509c is circumferentially constructed in at least one segment wherein each segment is linearly constructed (as shown in 509a) or circumferentially wound or rolled (as shown in 509c). The electromagnetic forces generated by the peripheral electromagnetic guides 509a and 509c act as a frictionless bearing surface which keeps rotor 507 isolated in space and acts as a magnetic bearing to physically suspend the rotor 507 preventing contact with large stators 504, peripheral electromagnetic guides 509a and 509c, and other surfaces. The same structure may be constructed using small stators 504a. Affixed inside of rotor 507 is integral auger type blade 516. Integral auger type blade 516 rotates with rotor 507 and creates powerful wakes of linear wave magnetic flux as rotor 507 is electrically charged and rotates at high speed. This linear wave of generated magnetic flux efficiently propels a spacecraft through space by interacting with existing magnetic flux fields.

Rotor 507 may be constructed of lightweight electrically conductive and or diamagnetic materials able to withstand high temperatures and hold a high electric charge including, but not limited to superconductors, copper, aluminum, iron, steel, magnesium, etc. and or alloys thereof. Rotor 507 is designed to operate in harsh environments (such as the vacuum of space) where minimal positively charged hydrogen and helium ions and negatively charged electrons exist and electric arcing may be minimized when rotor 507 is electrically charged. Optionally, rotor 507 may be lined and/or enameled and/or varnished with thin layers of electrical insulating materials including, but not limited to: polymers, polymeric plastic, resins, rubbers, plastics, polyvinylchloride, pure cellulose paper, glass, and so on, to further prevent electric arcing when rotor 507 is electrically charged.

Rotor 507 is supported and stabilized by two concentric guide channels 507c and 507d in which two peripheral electromagnetic guides 509a and 509c circumferentially run. Each peripheral electromagnetic guide 509a and 509c is circumferentially constructed in at least one segment wherein each segment is linearly constructed (as shown in 509a or 509b) or circumferentially wound or rolled (as shown in 509c). The electromagnetic forces generated by the peripheral electromagnetic guides 509a or 509b and 509c act as a frictionless bearing surface which keeps rotor 507 isolated in space and act as a magnetic bearing to physically suspend the rotor 507 preventing contact with large stators 504, peripheral electromagnetic guides 509a or 509b or 509c, and other surfaces. The same kind of structure may be used with small stators 504a.

An alternative embodiment of main engine ring 517 has at least one friction braking and support assembly comprising braking system support bracket 510, solenoid 511, brake assembly retracting spring 511a, brake arm actuator pin 511b, brake arm 512, brake arm pivot pin 512a, brake pad 513, and brake liner 514 are shown. Those having skill in the art will recognize that brake pad 513 and brake liner 514 may be constructed of various materials including, but not limited to, nylon, composite, and ceramic materials. Also, those having skill in the art will recognize that brake pad 513 and brake liner 514 may be associated with a heat dissipating radiator. Also, those having skill in the art will recognize that usually at least two braking and support assemblies are provided and that when more than one braking and support assemblies are provided that they are spaced equally along the shown circle of main engine ring 517. Also, those having skill in the art will recognize that an electromagnetic induction braking system may also, or, alternately, be included. Also, those having skill in the art will recognize that braking and support assemblies may be affixed to both the left and right sides of main engine ring 517.

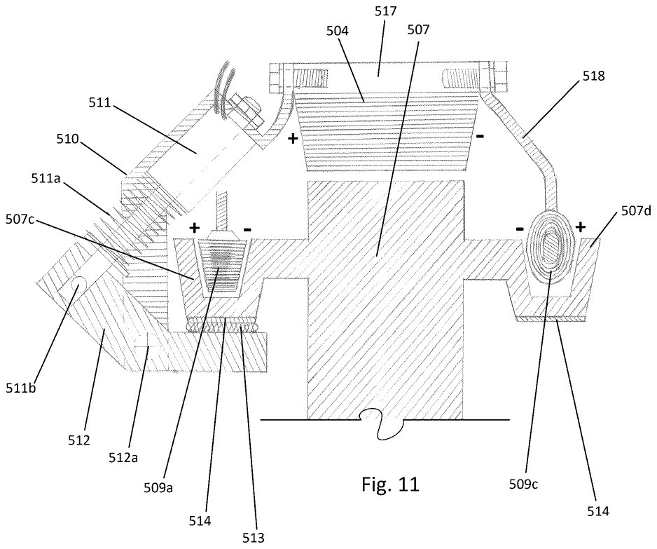

FIG. 11 shows a front cutaway view of rotor 507 with braking and support system. As presently shown solenoid 511 is not electrically energized and retracting spring 511a is extended thus automatically activating said braking system to suspend said rotor 507 and preventing it from making contact with surfaces. Energizing solenoid 511 will compress retracting spring 511a to deactivate braking system as power is applied to the entire system thus allowing said rotor 507 the freedom to rotate as it simultaneously gets energized by stators 504 and or 504a. Those having skill in the art will recognize that many other types of braking systems may be used including disc braking systems and friction braking systems impinging on other parts of rotor 507 or working by means of electromagnetically inducing current in stator(s) included in the circumferential ring of individual stators 504r.

Inside the circumference of main engine ring 517 is the circumferential ring of individual stators 504r. Those having skill in the art will recognize that different sizes and shapes of stators including large stators 504 and small stators 504a may comprise the circumferential ring of individual stators 504r. Radially inside main engine ring 517 and the circumferential ring of individual stators 504r is at least one peripheral electromagnetic guide (i.e. 509a, or 509b, or 509c).

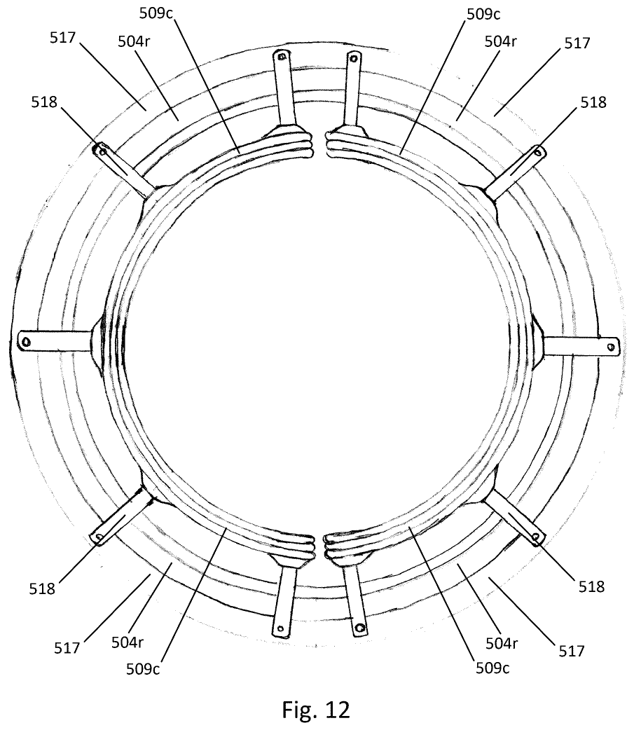

Referring now specifically to FIG. 12, two peripheral electromagnetic guides 509c are shown each comprising approximately half of the circumferential length of the shown circle. Peripheral electromagnetic guides 509c are affixed to main engine ring 517 by support arms 518.

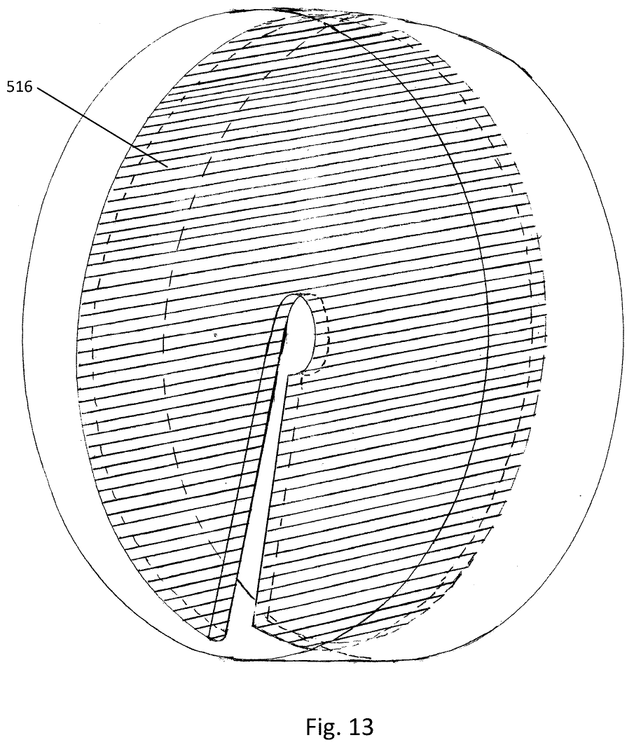

Referring now to FIG. 13, the shape of an integral auger type blade 516 is shown as it lies inside a rotor. Integral auger type blade 516 is spiral in shape and may have any spiral height. Integral auger type blade 516 may have a fixed, or, varying spiral height. Those having skill in the art will recognize that auger type blade 516 may possess more than one rotation and there may be more than one auger type blade 516 aligned along the rotational axis of the rotor.

An electronic controller will monitor and control all processes and operations of said magnetic flux drive. The electronic controller controls the application of electrical current to all of the components of the magnetic flux drive including the: 1) Peripheral electromagnetic guides (509a, or 509b, or 509c); 2) Large stators 504 or the small stators 504a; and, 3) Concentric guide channels 507c and 507d. Attaching and or mounting the magnetic flux generator to the main body or fuselage of a craft on both sides, fore and aft, may afford attitude and/or directional control of the craft depending on how the electromagnetic field generated by the rim driven propellor (RDP) unit 508 is directed to interact with the existing, ambient magnetic flux present in the environment.

Referring now to FIGS. 7 and 8a, Those having skill in the art will recognize that such that when members of the array of stators 504 are sequentially energized: 1) The rotor 507 rotates; 2) The rotor 507 is electrically charged by the stators 504; 3) A spiraling electromagnetic flux field is created by the rotor 507 wherein the spiraling electromagnetic flux field is centrally aligned along the rotational axis of the rotor 507; and, 4) The spiraling electromagnetic flux field is emitted such that its input (north pole) is directed to one end of the central conduit and the output (south pole) is directed toward the output end of the central conduit. The craft wherein the electromagnetic flux generator is affixed is propelled by the emitted spiraling electromagnetic flux field as it interacts with the existing, ambient magnetic field.

It is to be understood that the present invention is not limited to the illustrations and details shown. Those skilled in the art may modify elements and aspects described but may not deviate from the spirit and scope of the claims. For example, those having skill in the art will recognize that the directional orientation of the magnetic field generated by rim driven propellor (RDP) unit 508 particularly as shown in FIGS. 9, 10, and 11 may be essentially reversed by changing the polarity of the electrical circuit energizing: 1) The large and small stators 504 and 504a; and, 2) The peripheral electromagnetic guides 509a, 509b, or 509c.

Also, those having skill in the art will recognize that in the embodiment of the invention shown in FIGS. 7, 8a, 8b, 8c, 9, 10, and 11 electric power may be generated when electric power coils 506 are affixed and are exposed to the magnetic flux generated by rotor 507 when it rotates.

Also, it will be obvious to those having skill in the art that electric power to energize the devices disclosed may be provided by numerous electrical power sources, including, but not limited to, solar panels, nuclear reactors, fusion reactors, and such generated electric power may be stored in batteries. Further, FIGS. 9, 10, and 11 indicate the electrical polarity of the current to be applied from the chosen electrical source to the disclosed embodiment of the invention. This indication is made by means of “+” and “−” annotations on the drawings. Further, the directional orientation of the magnetic field generated by the magnetic flux generator may be reversed by reversing the polarity of the electrical current supplied to the rim driven propellor (RDP) unit 508.

Also, those having skill in the art will recognize that outer space (or simply space) is the expanse beyond celestial bodies and their atmospheres. Outer space is not completely empty; it is a near perfect vacuum containing a low density of particles, predominantly a plasma of positively charged hydrogen and helium ions and negatively charged electrons.

A focused stream of electrons or ions may created when the magnetic flux generation system is activated. The focused stream of electrons is directed along the magnetic field lines of the magnetic flux generation system. One having skill in the art will recognize that electrons or ions may be captured according to electrical charge relative to the input of the magnetic flux generation system and those electrons or ions are directed linearly along the magnetic field lines through the output of the magnetic flux generation system, thus creating a thrust directed towards the input of the magnetic flux drive.

What is claimed:

1. An electromagnetic flux generator comprised of:
a) a power source;
b) a central conduit with a perpendicularly mounted rim driven propellor (RDP) unit mounted at its center;
c) wherein the RDP is comprised of a centrally located rotor in the form of an integral auger type blade constructed of electrically conductive or super conducting material;
i. held laterally in place by magnetic bearings;
ii. held at its rotational center by an array of energized stators;
iii. wherein the position and speed of the rotors is monitored by an array of location sensors located along the lateral aspects of the rotor;
iv. wherein the power source is connected to the stators and the power is sequenced by an electronic controller;
d) wherein the central conduit is circumscribed by at least one row of electrical coils constructed of electrically conductive or super conducting material;
e) wherein electric power coils are located laterally to the RDP;
f) wherein the central conduit, the RDP, and the electric power coils are located in a nacelle/pod which is affixed to a shaft;
g) wherein the nacelle/pod is rotatable with respect to the shaft;
h) wherein the shaft is rotatable in both axes with respect to the spacecraft;
i) such that when members of the array of stators are sequentially energized:
i. the rotor rotates;
ii. the rotor is electrically charged by the stators;
iii. a spiraling electromagnetic flux field is created by the rotor wherein the spiraling electromagnetic flux field is centrally aligned along the rotational axis of the rotor, and, the spiraling electromagnetic flux field is emitted such that its input (north pole) is directed to one end of the central conduit and the output (south pole) is directed toward the output end of the central conduit;
iv. wherein a craft in which the electromagnetic flux generator is affixed is propelled by the emitted spiraling electromagnetic flux field as it interacts with the existing, ambient magnetic field.

2. An electromagnetic flux generator of claim 1 wherein the direction of travel may be reversed by reversing the polarity of the electrical current supplied to the RDP.

3. An electromagnetic flux generator of claim 1 further comprising a braking system.

4. An electromagnetic flux generator for spacecraft propulsion of claim 3 wherein the braking system is operated by friction.

5. An electromagnetic flux generator of claim 3 wherein the braking system is operated by electromagnetic induction.

6. An electromagnetic flux generator comprised of:
a) a power source;
b) a central conduit with a perpendicularly mounted rim driven propellor (RDP) unit mounted at its center;
c) wherein the RDP is comprised of a centrally located rotor in the form of an integral auger type blade constructed of electrically conductive or super conducting material;
i. held laterally in place by at least two peripheral electromagnetic guides each operating inside concentric guide channels;
ii. held at its rotational center by an array of energized stators;
iii. wherein the position and speed of the rotors is monitored by an array of location sensors located along the lateral aspects of the rotor;
iv. wherein the power source is connected to the stators and the power is sequenced by an electronic controller;
d) wherein the central conduit is circumscribed by at least one row of electrical coils constructed of electrically conductive or super conducting material;
e) wherein electric power coils are located laterally to the RDP;
f) wherein the central conduit, the RDP, and the electric power coils are located in a nacelle/pod which is affixed to a shaft;
g) wherein the nacelle/pod is rotatable with respect to the shaft;
h) wherein the shaft is rotatable with respect to the spacecraft;
i) such that when members of the array of stators are sequentially energized:
i. the rotor rotates;
ii. the rotor is electrically charged by the stators;
iii. a spiraling electromagnetic flux field is created by the rotor wherein the spiraling electromagnetic flux field is centrally aligned along the rotational axis of the rotor, and, the spiraling electromagnetic flux field is emitted such that its input (south pole) is directed to one end of the central conduit and the output (north pole) is directed toward the other end of the central conduit; and
iv. wherein the spacecraft is propelled by the emitted spiraling, generated electromagnetic flux field as it interacts with the existing, ambient magnetic field.

7. An electromagnetic flux generator for spacecraft propulsion of claim 6 wherein the direction of travel may be reversed by reversing the polarity of the electrical current supplied to the RDP.

8. An electromagnetic flux generator for spacecraft propulsion of claim 6 further comprising a braking system.

9. An electromagnetic flux generator for spacecraft propulsion of claim 8 wherein the braking system is operated by friction.

10. An electromagnetic flux generator for spacecraft propulsion of claim 8 wherein the braking system is operated by electromagnetic induction.
